(19) United States
(12) Patent Application Publication
(10) Pub. No.: US 2025/0287199 A1
(43) Pub. Date: Sep. 11, 2025

(54) OVER-THE-AIR COMPUTING (OTAC) OVER A MULTIPLE ACCESS CHANNEL

(71) Applicant: LENOVO (SINGAPORE) PTE LIMITED, Singapore (SG)

(72) Inventors: Razvan-Andrei STOICA, Essen (DE); Seyedomid TAGHIZADEH MOTLAGH, Oberursel (DE); Sheeba Backia Mary BASKARAN, Friedrichsdorf (DE)

(21) Appl. No.: 18/858,660

(22) PCT Filed: Apr. 20, 2023
(86) PCT No.: PCT/IB2023/054052

§ 371 Date: Oct. 21, 2024

Related U.S. Application Data
(60) Provisional application No. 63/333,933, filed on Apr. 22, 2022.

(51) Int. Cl. H04W 12/03; H04B 7/06; H04L 9/00; H04W 12/00

(52) U.S. Cl. CPC H04W 12/03; H04B 7/0626; H04L 9/008; H04W 12/009

(57) ABSTRACT

Various aspects of the present disclosure relate to a securing over-the-air computing (OTAC) using encryption techniques, such as homomorphic encryption (HE). Various network components (e.g., a network entity or a user device) can employ a combination of HE and an OTAC configuration to data transmitted between the nodes (e.g., data sent from multiple sensor nodes to an aggregator node). Thus, the combination of HE and OTAC provides a privacy and data confidentiality mechanism over the MAC, facilitating the use of OTAC over a public channel (e.g., the MAC) without the reliance on physical security schemes or other cumbersome mechanisms, among other benefits.

### CROSS REFERENCE TO RELATED APPLICATIONS

This application claims priority to U.S. Provisional Patent Application No. 63/333,933, filed on Apr. 22, 2022, entitled OVER-THE-AIR COMPUTING (OTAC) OVER A MULTIPLE ACCESS CHANNEL, which is hereby incorporated by reference in its entirety.

### TECHNICAL FIELD

The present disclosure relates to wireless communications, and more specifically to over-the-air computing (OTAC) over multiple access channels (MACs) of a wireless communications system.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G.

In some cases, the wireless communications system may implement OTAC. For example, some communication devices may implement OTAC, which may support air-interface or medium computing over physical channels of the wireless communication system and, as a result, provide multiple access and superposition properties. A MAC, which can be provided by electro-magnetic channels (e.g., radio frequency (RF) wireless, visible light communications (VLC) channels), and/or electro-mechanic channels (e.g., vibrational channels, audio channels), can implement OTAC to facilitate or support superposition and advanced functional representations to compute various results over medium resources (e.g., channel resources), instead of physical computing devices (e.g., central processing unit (CPU), microcontroller unit (MCU), application servers, etc.). Therefore, the use of OTAC can lead to benefits resulting from fewer resource utilization of a medium, energy and latency savings, and so on.

### SUMMARY

The present disclosure relates to methods, apparatuses, and systems that support securing OTAC operations using an encryption scheme, such as homomorphic encryption (HE).

A wireless communications system may deploy multiple network nodes, which may include multiple sensor nodes for sending data to one or more aggregator nodes. In some implementations, some sensor nodes may transmit sensor information (e.g., data) to a single node in the wireless communications system over a communication channel (e.g., a MAC). The single node may be referred to as an aggregator node that aggregates (e.g., combines, collects, and so on) sensor information from the sensor nodes. In some cases, there may be a security threat associated with the exchange of the sensor information (e.g., data) between a sensor node and an aggregator node. This security threat may impact the integrity of the exchanged sensor information, as well as an integrity of the respective sensor nodes. To mitigate or decrease security threats in the wireless communications system, the wireless communication system (e.g., one or more communication devices, such as a network entity and/or a UE) may encrypt the sensor information (e.g., data) in accordance with an OTAC configuration and an HE. By using both the OTAC configuration and the HE, the wireless communications system may maintain a privacy and data confidentiality for the communication channel irrespective of other physical security schemes.

Some implementations of the method and apparatuses described herein may further include a network entity that transmits to multiple sensor nodes an OTAC configuration and a HE configuration, receives encrypted data over a MAC based on the OTAC configuration from the multiple sensor nodes, and decrypts the received encrypted data using the HE configuration.

In some implementations of the method and apparatuses described herein, decrypting the received encrypted data using the HE configuration includes decrypting the received encrypted data as an OTAC aggregated result and computing an objective function for the data that is based on the OTAC aggregated result and the OTAC configuration.

In some implementations of the method and apparatuses described herein, the HE configuration includes a public HE configuration and a private HE configuration.

In some implementations of the method and apparatuses described herein, the HE configuration includes a public HE configuration and a private HE configuration; and wherein configuring the multiple sensor nodes includes configuring the multiple sensor nodes to encrypt data using the public HE configuration and not the private HE configuration.

In some implementations of the method and apparatuses described herein, the network entity determines the HE configuration as: a Partial Homomorphic Encryption (PHE) encryption scheme, a Somewhat Homomorphic Encryption (SWE) encryption scheme, or a Full Homomorphic Encryption (FHE) encryption scheme.

In some implementations of the method and apparatuses described herein, the network entity determines the HE configuration based on a desired bit security guarantee, a data input space, a desired threshold of sensor nodes superposed by a MAC superposition of the MAC, a desired threshold of residual noise during the decryption of the received encrypted data without a decryption processing failure, a function objective calculated during the decryption of the received encrypted data, a table description of supported HE cryptographic schemes, and/or a modulation and coding scheme of the OTAC configuration.

In some implementations of the method and apparatuses described herein, the HE configuration is based on a selected HE cryptographic scheme, a public-private key pair, a relinearization key, a secret key, an invertible encoding of data input space to plaintext space of a selected HE scheme, and/or an invertible encoding of ciphertext space of a selected HE scheme to an intermediate space of an OTAC transceiver processing modulation and coding scheme for the OTAC configuration.

In some implementations of the method and apparatuses described herein, decrypting the received encrypted data using the HE configuration includes embedding an asymmetric cryptographic primitive.

In some implementations of the method and apparatuses described herein, the HE configuration is homomorphic with respect to addition.

In some implementations of the method and apparatuses described herein, the network entity determines the OTAC configuration based on a function objective to be calculated, channel state information (CSI) for the multiple sensor nodes, multiple reference signals (RS) reports for timing advance determination for the multiple sensor nodes, one or more precoders and combiners for spatial beamforming available to the multiple sensor nodes, radio transceiver capabilities of the multiple sensor nodes, and/or a set of available time and frequency communication resources.

In some implementations of the method and apparatuses described herein, the OTAC configuration is based on an OTAC radio processing configuration of an OTAC transmission filter and/or an OTAC analytics processing configuration of a pre-filter.

In some implementations of the method and apparatuses described herein, the OTAC radio processing configuration of the OTAC transmission filter, for each of the multiple sensor nodes, includes an indication signaling a receiver spatial filter of the network entity, a transmitter spatial filter at the sensor node, a transmission pattern for time multiplexing, a transmission pattern for frequency multiplexing, and/or a timing advance configuration.

In some implementations of the method and apparatuses described herein, the MAC is an electro-magnetic channel or an electro-mechanic channel.

Some implementations of the method and apparatuses described herein may further include a method performed by a network entity of transmitting to one or more sensor nodes an OTAC configuration and a HE configuration, receiving encrypted data over a MAC based on the OTAC configuration from any of the one or more sensor nodes, and decrypting the received encrypted data using the HE configuration.

In some implementations of the method and apparatuses described herein, decrypting the received encrypted data using the HE configuration includes decrypting the received encrypted data as an OTAC aggregated result and computing an objective function for the data that is based on the OTAC aggregated result and the OTAC configuration.

In some implementations of the method and apparatuses described herein, the HE configuration is a Partial Homomorphic Encryption (PHE) encryption scheme, a Somewhat Homomorphic Encryption (SWE) encryption scheme, or a Full Homomorphic Encryption (FHE) encryption scheme.

Some implementations of the method and apparatuses described herein may further include a sensor node that receives an OTAC configuration and a HE configuration from an aggregator node of a network and transmits encrypted data to the aggregator node over a MAC, where the encrypted data is configured using the OTAC configuration and encrypted using the HE configuration.

In some implementations of the method and apparatuses described herein, the sensor node pre-filters data input as message data input using the OTAC configuration and encrypts the message data input as the encrypted data using the HE configuration.

In some implementations of the method and apparatuses described herein, the HE configuration is a public HE configuration that includes a selected HE cryptographic scheme, a public encryption key, an invertible encoding of data input space to plaintext space of a selected HE scheme, and/or an invertible encoding of ciphertext space of a selected HE scheme to an intermediate space of an OTAC transceiver processing modulation and coding scheme.

In some implementations of the method and apparatuses described herein, the sensor node encodes a data input from a data space to a plaintext space, encrypts a plaintext representation to a ciphertext representation via cryptographic additive homomorphic encryption, and/or encodes a ciphertext representation to an input space of the OTAC configuration.

In some implementations of the method and apparatuses described herein, the OTAC configuration is based on an OTAC radio processing configuration of an OTAC transmission filter and/or an OTAC analytics processing configuration of a pre-filter.

In some implementations of the method and apparatuses described herein, the OTAC radio processing configuration of the OTAC transmission includes a receiver spatial filter of the aggregator node, a transmitter spatial filter at the sensor node, a transmission pattern for time multiplexing, a transmission pattern for frequency multiplexing, and/or a timing advance configuration.

In some implementations of the method and apparatuses described herein, the sensor node is an internet of things (IoT) device or a mobile device.

In some implementations of the method and apparatuses described herein, the MAC is an electro-magnetic channel or an electro-mechanic channel.

Some implementations of the method and apparatuses described herein may further include a system that comprises an aggregator node that determines an objective function for encrypted data aggregated over a MAC accessed by multiple sensor nodes; and multiple sensor nodes that simultaneously transmit encrypted data over the MAC to the aggregator node.

In some implementations of the method and apparatuses described herein, the aggregator node applies an OTAC configuration and a HE configuration to data transmitted over the MAC from the multiple sensor nodes to the aggregator node.

### BRIEF DESCRIPTION OF THE DRAWINGS

FIG. 1 illustrates an example of a wireless communications system that supports encrypted OTAC in accordance with aspects of the present disclosure.

FIG. 2A illustrates an example of an OTAC system that supports secure computing over MAC in accordance with aspects of the present disclosure.

FIG. 2B illustrates an example of OTAC over MAC in accordance with aspects of the present disclosure.

FIG. 3 illustrates a flowchart of a method that supports an aggregator node communicating with one or more sensor nodes in accordance with aspects of the present disclosure.

FIG. 4 illustrates a flowchart of a method that supports an aggregator node receiving information from one or more sensor nodes in accordance with aspects of the present disclosure.

FIG. 5A illustrates a flowchart of a method that supports a sensor node transmitting information over a MAC in accordance with aspects of the present disclosure.

FIG. 5B illustrates a flowchart of a method that supports a sensor node encrypting data having an OTAC configuration accordance with aspects of the present disclosure.

FIG. 6 illustrates an example of a diagram that supports encrypted OTAC in accordance with aspects of the present disclosure.

FIG. 7 illustrates an example of a diagram that supports timing of information transmission in an OTAC system in accordance with aspects of the present disclosure.

FIG. 8 illustrates an example of a block diagram of a device that supports encrypted OTAC in accordance with aspects of the present disclosure.

### DETAILED DESCRIPTION

One drawback of OTAC is a lack of security and privacy mechanisms to protect against eavesdroppers or malicious attackers. For example, nodes in an OTAC scheme transmit sensor input data over the air encoded as unencrypted waveforms to facilitate MAC computation. These unencrypted waveforms can be vulnerable to passive eavesdroppers, which can acquire individual sensor data and derive aggregation results of the sensor data, and/or active eavesdroppers or attackers, which can listen and inject false input data into the system, among other problems.

Typically, OTAC utilizes physical security schemes, constrained by transceiver design assumptions to yield a theoretical secrecy capacity level. This design problem imposes design constraints to communications nodes and may impact significantly practical product lifecycle development and/or product form factors, affecting feasible practical deployments, among other drawbacks.

In some embodiments, the network communication system can include an aggregator node (e.g., a base station or other network entity) and multiple sensor nodes (e.g., an IoT device, a UE or other similar sensor entities) that transmit data to the aggregator node via a MAC. The technology described herein, which combines OTAC and HE, facilitates the performance of data transmission/reception and data aggregation/computation over a physical channel (e.g., the MAC) between the multiple sensor nodes and the aggregator nodes.

For example, the technology is directed to securing waveforms communicated between nodes over a MAC when performing over-the-air computing, or OTAC. Various devices (e.g., a network entity or a user device) can employ a combination of homomorphic encryption (HE) and an OTAC configuration to data transmitted between the nodes (e.g., data sent from multiple sensor nodes to an aggregator nodes). Further, the technology described herein provides or enables secure and confidential waveform communications over a MAC by combining the OTAC with an encryption scheme that provide asymmetric encryption and homomorphism (for at least an addition operation), such as HE.

Thus, the combination of HE and OTAC provides a privacy and data confidentiality mechanism for the MAC, facilitating the use of OTAC over a public channel (e.g., the MAC) without the reliance on physical security schemes or other cumbersome mechanisms, among other benefits.

Aspects of the present disclosure are described in the context of a wireless communications system. Aspects of the present disclosure are further illustrated and described with reference to the following device diagrams and flowcharts that relate to securing OTAC data transmissions over a MAC between nodes of a wireless communications system.

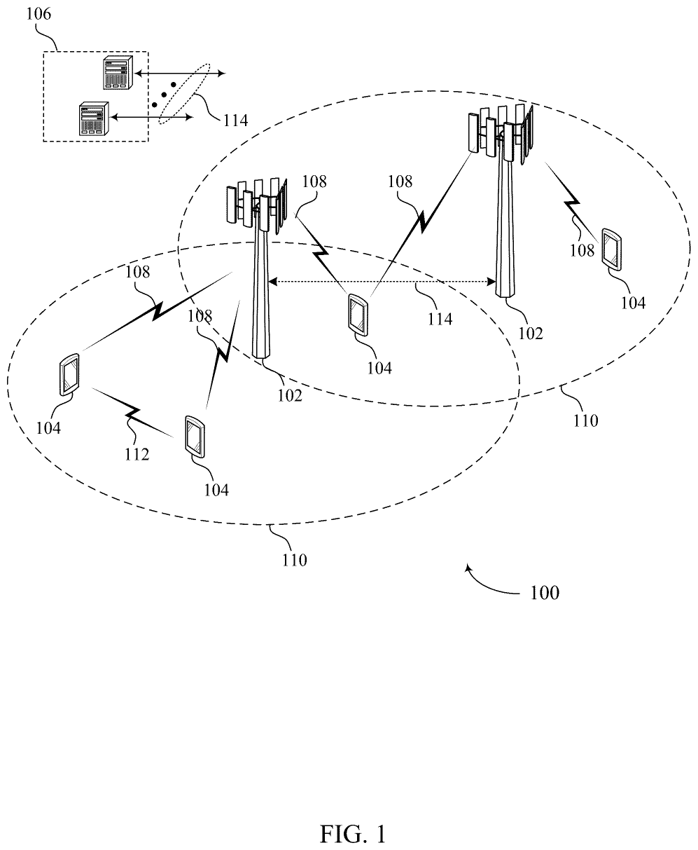

FIG. 1 illustrates an example of a wireless communications system 100 that supports encrypted OTAC in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 (e.g., aggregator nodes) may be dispersed throughout a geographic region to form the wireless communications system 100. One or more of the base stations 102 described herein may be or include or may be referred to as a base transceiver station, an access point, a NodeB, an eNodeB (eNB), a next-generation NodeB (gNB), or other suitable terminology. A base station 102 and a UE 104 may communicate via a communication link 108, which may be a wireless or wired connection. For example, a base station 102 and a UE 104 may wirelessly communicate over a Uu interface.

A base station 102 may provide a geographic coverage area 110 for which the base station 102 may support services (e.g., voice, video, packet data, messaging, broadcast, etc.) for one or more UEs 104 within the geographic coverage area 110. For example, a base station 102 and a UE 104 may support wireless communication of signals related to services (e.g., voice, video, packet data, messaging, broadcast, etc.) according to one or multiple radio access technologies. In some implementations, a base station 102 may be moveable, for example, a satellite associated with a non-terrestrial network. In some implementations, different geographic coverage areas 110 associated with the same or different radio access technologies may overlap, but the different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 (e.g., sensor nodes) may be dispersed throughout a geographic region of the wireless communications system 100. A UE 104 may include or may be referred to as a mobile device, a wireless device, a remote device, a handheld device, a user device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, an integrated access and backhaul (IAB) node, or another network equipment), as shown in FIG. 1. Additionally, or alternatively, a UE 104 may support communication with other base stations 102 or UEs 104, which may act as relays in the wireless communications system 100.

A UE 104 may also be able to support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or another network interface). The base stations 102 may communicate with each other over the backhaul links 114 (e.g., via an X2, Xn, or another network interface). In some implementations, the base stations 102 may communicate with each other directly (e.g., between the base stations 102). In some other implementations, the base stations 102 may communicate with each other or indirectly (e.g., via the core network 106). In some implementations, one or more base stations 102 may include subcomponents, such as an access network entity, which may be an example of an access node controller (ANC). An ANC may communication with the one or more UEs 104 through one or more other access network transmission entities, which may be referred to as radio heads, smart radio heads, or transmission-reception points (TRPs).

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

The wireless communications system 100 may support encrypted OTAC between nodes of the wireless communications system 100, such as between the base station 102 (e.g., an aggregator node) and multiple UEs 104 (e.g., sensor nodes). Each UE 104 may exchange information (e.g., data) over a respective MAC with the base station 102.

OTAC relies on the analog computation by superposition principle of interfering distributed information sources over a MAC. The MAC represents an information theoretical channel model underlying the superposition principle whereby the simultaneous transmissions from two or more sources are added analogously at a receiver over the transmission medium (e.g., electro-magnetic channels and/or electro-mechanic channels). OTAC utilizes interference to perform functional computation of distributed sensor nodes over the single channel.

In an OTAC scheme, one common communication channel resource, the MAC, can facilitate data communications and perform data computations at the same time by leveraging interference and superposition principles of the MAC. Thus, OTAC can perform such aggregation of wireless data by (1) synchronizing distributed inputs to a slot or symbol duration to align distributed data sources (e.g., sensor nodes) over the MAC, (2) by pre-equalizing individual uplink (UL) channels of the distributed data sources of each of the data sources, and (3) by jointly post-processing at the receiver node the acquired MAC superimposed signal to ensure the distributed data sources are uniformly contributing (e.g., aggregating) towards a desired computation function for the OTAC.

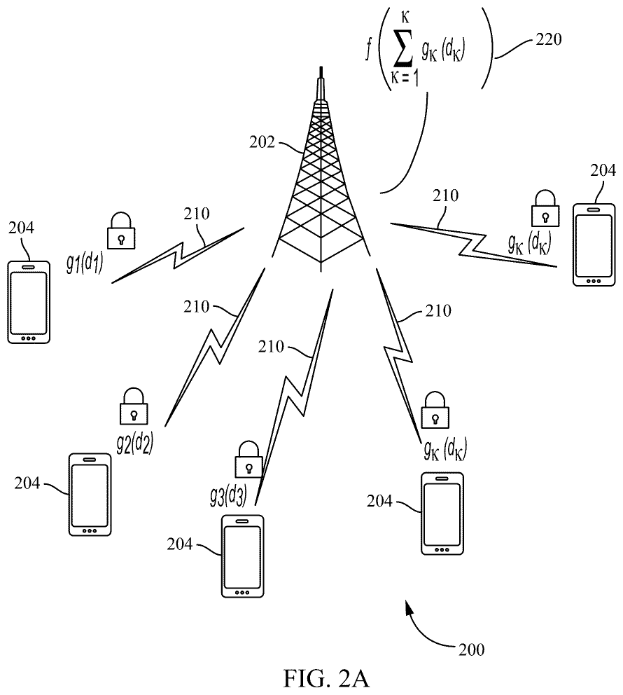

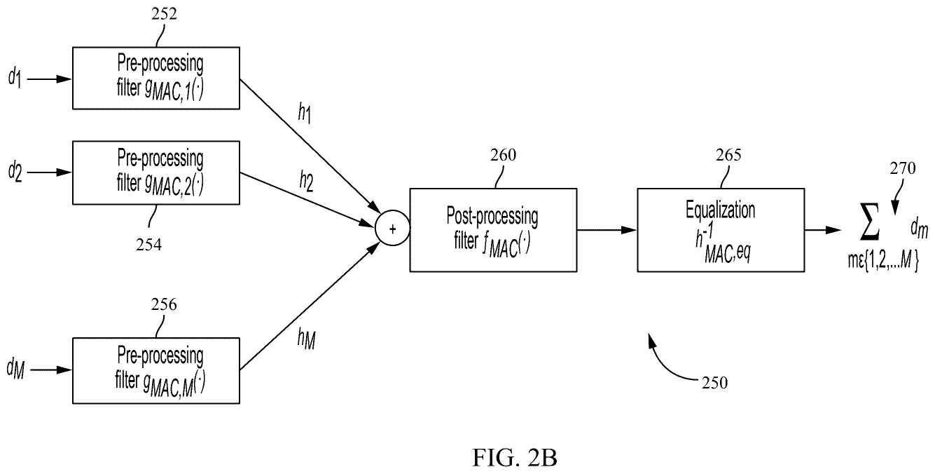

FIG. 2A illustrates an example of an OTAC system 200 that supports secure/encrypted computing over a MAC in accordance with aspects of the present disclosure. The OTAC system 200 may implement or be implemented by aspects of the wireless communications system 100 as described in FIG. 1.

As described herein, the systems and methods embed a HE cryptographic scheme into an OTAC system to provide data confidentiality and privacy to the OTAC system. Although there is an intrinsic characteristic within an OTAC scheme to transmit waveform encoding sensor input data from a sensor node without encryption to an aggregation node, to realize the MAC superposition property, additively homomorphic cryptographic mechanisms (e.g., HE) can combine with the OTAC scheme to maintain the superposition property of the channel while securing the data transmitted via the channel.

An example OTAC system 200 includes multiple communication nodes, such as one or more sensor nodes 204 (e.g., the UEs 104) that communicate simultaneously with an aggregator node 202 (e.g., the base station 102). In some cases, at least sensor nodes 204 communicate simultaneously over shared channel resources (e.g., time, frequency, mode, code, spatial resources, and so on) in Uplink (UL) to a receiving node, such as the aggregator node 202.

FIG. 2B illustrates an example of OTAC over MAC 250 in accordance with aspects of the present disclosure. For example, the pre-processing g_{MAC,1}(•), g_{MAC,2}(•), . . . , g_{MAC,M}(•) operations 252, 254, 256 and post-processing ƒ_{MAC}(•) operation 260 can jointly normalize all the individual UL channels closely to an equivalent common normalized channel h_{MAC,eq}(•) 265, such that a superimposed waveform 270 received at an OTAC aggregator node can allow for the recovery of the aggregate of the sensor nodes input data.

For example, referring to FIG. 2A, the sensor nodes 204 transmit information or data in UL to the aggregator node 202 over a MAC 210. The aggregator node 202 leverages the non-orthogonal multiple access UL scheme and superposition principle of the MAC 210 to aggregate the UL waveforms of the sensor nodes 204 into one single superimposed waveform forming the input signal. In other words, the aggregator node 202 utilizes the aggregated waveform due to the non-orthogonal MAC to jointly process the received waveform of the separate sensor nodes 204.

The aggregator node 202 can be a network entity, such as the base station 102 (e.g., a gNB in 5G NR, an AP in Wi-Fi, a MasterNode in Bluetooth, a controller in ZigBee, a recording microphone for audio/ultrasonic channels, and so on), and receives information via the simultaneous UL transmission from the sensor nodes 204 over the MAC 210.

In some embodiments, the aggregator node 202 determines an OTAC configuration for at least two of the sensor nodes 204 (or any of the nodes 204) scheduled for simultaneous UL transmission to the aggregator node 202, determines a HE configuration for the sensor nodes 204 and itself, configures the sensor nodes 204 with the OTAC configuration and the HE configuration (or transmits the configurations), applies the OTAC configuration to receive a MAC superposition of encrypted data of transmissions of the sensor nodes 204, decrypts the received MAC superposition of encrypted data as an OTAC aggregated result using the HE configuration, and/or computes a functional ƒ of the OTAC aggregated result using the OTAC configuration.

As described herein, the sensor nodes 204 can be the UE 104, such as an IoT device, a mobile device, a vehicle equipped with a radio unit, a speaker, and so on), which performs UL transmission of information/data. In some embodiments, the sensor node 204 configures data with the OTAC configuration received from an aggregator node 202, configures a HE public configuration received from the aggregator node 202 for the configured data, pre-filters a data input using the OTAC configuration, encrypts the data input using the HE configuration, and/or applies the OTAC configuration to transmit the encrypted data to the OTAC aggregator node 202.

As an example, the OTAC system 200 of FIG. 2 includes K sensor nodes 204 performing HE encrypted data transmissions in UL over the shared MAC 210 to the aggregator node 202. The aggregator node 202 computes a functional ƒ(Σₖ₌₁^{K} gₖ(dₖ)) 220 of the OTAC aggregated result Σₖ₌₁^{K} gₖ(dₖ). The individual data transmissions, or gₖ(dₖ), of the K sensor nodes 204 are encrypted by means of a common HE configuration configured by or transmitted to the sensor nodes 204 by the aggregator node 202.

The simultaneous UL transmissions of the K sensor nodes 204 over the same channel resources, the MAC 210, enable the superposition of the K individual OTAC encoded and modulated waveforms into one superimposed waveform received by the aggregator node 202. The node 202 demodulates and decodes the superimposed waveform (e.g., via a demodulator and decoder of the node 202).

The node 202 decrypts the demodulated/decoded waveform using the HE configuration to yield an OTAC aggregated noisy variant of the plaintext Σₖ₌₁^{K} gₖ(dₖ), which is subsequently transformed to the desired result ƒ(Σₖ₌₁^{K} gₖ(dₖ)) 220 by means of the determined and shared OTAC configuration.

For example, the aggregator node 202 can compute any continuous multivariate real function of the sensor node data inputs using HE as a nomographic ƒ(Σₖ₌₁^{K} gₖ(dₖ)) distributed function (e.g., any real continuous multivariate function is decomposed as a nomographic representation).

As another example, the aggregator node 202 can asymptotically approximate any non-continuous multivariate real function of the sensor node data inputs using HE as a nomographic ƒ(Σₖ₌₁^{K} gₖ(dₖ)) distributed function (e.g., any real non-continuous multivariate function is represented as a nomographic approximation). The nomographic representation includes a post-processing functional ƒ applied by the aggregator node 202 and a distributed pre-filtering step gₖ, including an OTAC functional post-processing, by the aggregator node 202, where the ƒ, gₖ filters are selected based on an applied OTAC configuration. Thus, the aggregator node 202 can implement the combined OTAC configuration and HE configuration for communications between nodes over the MAC 210.

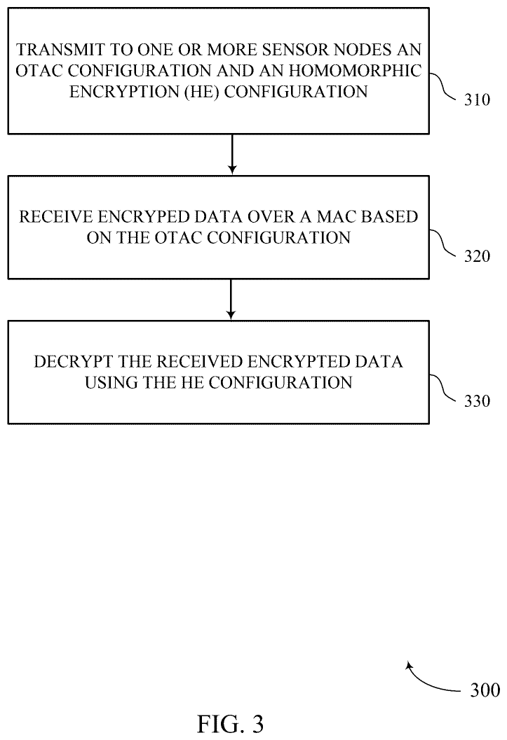

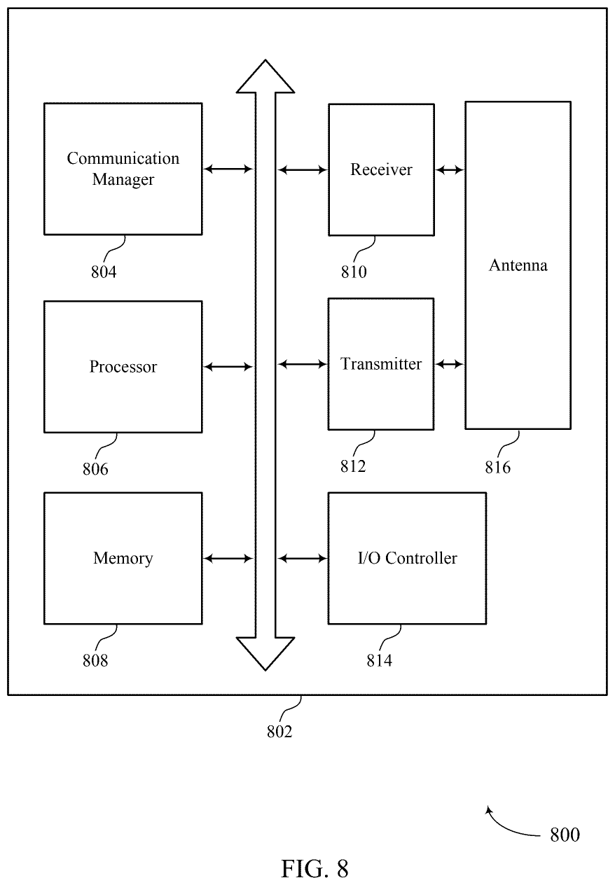

FIG. 3 illustrates a flowchart of a method 300 that supports an aggregator node communicating with one or more sensor nodes in accordance with aspects of the present disclosure. The operations of the method 300 may be implemented by a device or its components as described herein. For example, the operations of the method 300 may be performed by the base station 102 as described with reference to FIG. 8. In some implementations, the device may execute a set of instructions to control the function elements of the device to perform the described functions. Additionally, or alternatively, the device may perform aspects of the described functions using special-purpose hardware.

At 310, the method 300 may include transmitting to one or more sensor nodes an OTAC configuration and an HE configuration. The operations of 310 may be performed in accordance with examples as described herein. In some implementations, aspects of the operations of 310 may be performed by a device as described with reference to FIG. 1.

At 320, the method 300 may include receiving encrypted data over a MAC based on the OTAC configuration from any of the sensor nodes. The operations of 320 may be performed in accordance with examples as described herein. In some implementations, aspects of the operations of 320 may be performed by a device as described with reference to FIG. 1.

At 330, the method 300 may include decrypting the received encrypted data using the HE configuration. The operations of 330 may be performed in accordance with examples as described herein. In some implementations, aspects of the operations of 330 may be performed by a device as described with reference to FIG. 1.

As described herein, the aggregator node 202 implements the OTAC configuration combined with the HE configuration. HE is an asymmetric cryptography that allows mathematical operations on ciphertext representation of data instead of the data plaintext representation (e.g., HE can perform computations on encrypted data without first decrypting the data). Thus, with HE, a same output is obtained from decrypting the functionally operated ciphertext as from simply functionally operating on the initial plaintext.

The node 202 can split or separate the OTAC processing into different domains, such as: (1) an OTAC physical computation domain where the MAC 210 undergoes superposition of waveforms and OTAC aggregation; (2) an OTAC radio domain whereby distributed transceiver processing for enabling the OTAC physical computation domain processing is performed (at transmitters of the sensor nodes 204 and/or at a receiver of the aggregator node 202); and (3) an OTAC analytics domain where the determined nomographic representation of the functional result to be computed is distributedly applied by pre-processing functions gₖ at each k sensor node 204 and by the post-processing function ƒ at the aggregator node 202.

HE can include or be implemented as various forms or encryption schemes, and provide partially homomorphic encryption, somewhat homomorphic encryption, leveled fully homomorphic encryption, and full homomorphic encryption. For example, HE can be in partial form (e.g., Partial Homomorphic Encryption (PHE)) and/or in full form (e.g., Full Homomorphic Encryption (FHE)).

For example, the OTAC system 200 determines, configures, and distributedly processes the cryptographic homomorphic encryption as a HE security domain to provide a ciphertext representation of the plaintext data of the sensor nodes 204. In some cases, the HE security domain processing is represented by a HE mechanism that is homomorphic with respect to the addition operation, such as an additive PHE (e.g., addition or multiplication of ciphertexts is homomorphic with respect to the addition of plaintexts).

In some cases, the HE security domain processing is represented by a SHE scheme that is homomorphic with respect to any operation tolerated under an HE configuration of a maximum number of K sensor nodes 204, a maximum OTAC residual noise threshold, and/or a minimum OTAC Signal-to-Noise Ratio (SNR) threshold. In some cases, the HE security domain processing is represented by a FHE scheme that is homomorphic with respect to any mathematical operation.

Further, in some cases, the HE is an asymmetric cryptographic encryption/decryption method utilizing a public key (pk) for encryption and a secret key (sk) for decryption as a public-private key pair (pk, sk). The HE configuration of the OTAC system 200 can determine the HE scheme together with its key generation procedure.

The HE security domain processing can perform various functions for the OTAC system 200, including: encoding input data into a plaintext representation by providing an invertible first embedding from an input data space to the encryption scheme plaintext space, encrypting with a pk the plaintext representation as a ciphertext based on a HE scheme with at least additive homomorphism, encoding the ciphertext representation into an intermediate space by an invertible second embedding in preparation for lower layers OTAC radio processing (e.g., bit representation, complex domain representation), decoding the OTAC radio processing intermediate space by the inverse of the second embedding into a ciphertext representation, evaluating a ciphertext representation as an OTAC noisy addition of at least two ciphertexts, decrypting the evaluated ciphertext representation as the homomorphism of a noisy addition of plaintexts of at least two plaintexts, and/or decoding the noisy addition of plaintexts by the inverse of the first embedding back to the original data input space for further processing by upper layers OTAC analytics processing.

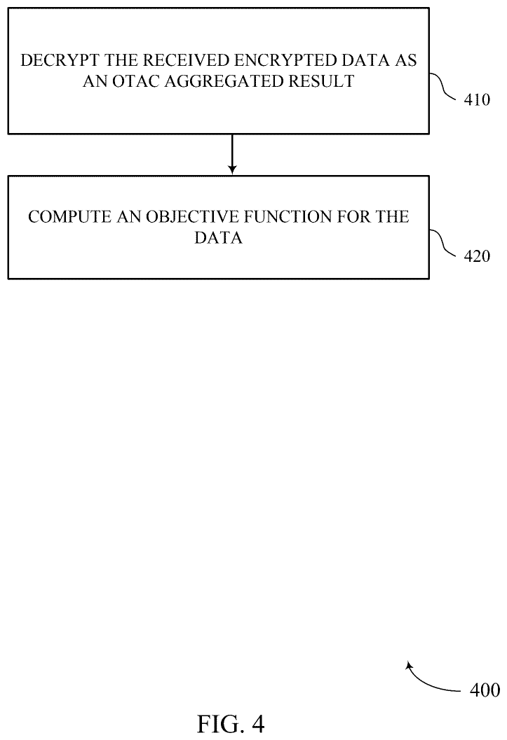

FIG. 4 illustrates a flowchart of a method 400 that supports an aggregator node receiving information from one or more sensor nodes in accordance with aspects of the present disclosure. The operations of the method 400 may be implemented by a device or its components as described herein. For example, the operations of the method 400 may be performed by the base station 102 as described with reference to FIG. 8. In some implementations, the device may execute a set of instructions to control the function elements of the device to perform the described functions. Additionally, or alternatively, the device may perform aspects of the described functions using special-purpose hardware.

At 410, the method 400 may include decrypting a received encrypted data as an OTAC aggregated result. The operations of 410 may be performed in accordance with examples as described herein. In some implementations, aspects of the operations of 410 may be performed by a device as described with reference to FIG. 1.

At 420, the method 400 may include computing an objective function for the data. The operations of 420 may be performed in accordance with examples as described herein. In some implementations, aspects of the operations of 420 may be performed by a device as described with reference to FIG. 1.

As described herein, the OTAC scheme or implementation across the MAC can have different configurations, depending on the resources or components associated with the MAC or the network. The aggregator node 202, as depicted in FIG. 2, can determine the OTAC configuration based on a variety of factors, including: (1) a function objective to be calculated, (2) channel state information (CSI) for each of the sensor nodes 204, (3) multiple reference signals (RS) measurements and/or measurement reports for time advance determination for each of the sensor nodes 204, (4) multiple precoders and combiners for spatial beamforming to each of the sensor nodes 204, (5) multiple radio transceiver capabilities of the sensor nodes 204 (e.g., transmit power levels, spatial beamforming characteristics, and so on), (6) active or multiple supported bandwidth partitions (BWPs) of each sensor node 204, and/or (7) a set of available time/frequency resources.

The aggregator node 202 can transmit the OTAC configuration having various components, including an OTAC radio processing configuration for an OTAC transmission filter g_{MAC,k}(•), and an OTAC analytics processing pre-filter gₖ(•). For example, the OTAC radio processing configuration for the OTAC transmission filter g_{MAC,k} (•) can include information for configuring a sensor node transceiver by signaling an Rx spatial filter at the aggregator node 202, a Tx spatial filter (e.g., beam precoder, beam selection) at the sensor node 204, a transmission time resource including a timing multiplexing pattern for transmission, a transmission frequency resource including a frequency multiplexing (e.g., resource elements (RE), pattern for transmission, and so on), and/or a timing advance configuration.

Similarly, the HE configuration can have different configurations, based on a variety of factors. The aggregator node 202 can determine the HE configuration based on: (1) a bit security guarantee, (2) a data input space, (3) a desired threshold of sensor nodes 204 that can be processed by the aggregator node 202, (4) a functional objective to be calculated, a desired threshold of residual noise that the aggregator node 202 can process without failing to decrypt the OTAC aggregated HE ciphertext, (5) a table description of supported HE cryptographic schemes, and/or (6) a modulation and coding scheme of the OTAC radio processing.

Further, the node 202 can form the HE configuration as a selected HE cryptographic scheme, a public-private key pair (pk, sk), a relinearization key, an encoding/decoding embedding of data input space to plaintext space of the selected HE cryptographic scheme, an encoding/decoding embedding of ciphertext space of the selected HE cryptographic scheme to an intermediate space (e.g., [symbol] , {0,1}, [symbol] ) of OTAC radio processing modulation and coding scheme, and so on.

Also, the node 202 can partition the HE configuration into a HE public configuration that is used to configure the sensor nodes 204. The HE public configuration partition can include a selected HE cryptographic scheme and its corresponding public parameters, a public key, an encoding/decoding embedding of data input space to plaintext space of the selected HE cryptographic scheme, an encoding/decoding embedding of ciphertext space of the selected HE cryptographic scheme to an intermediate space (e.g., ( [symbol] , {0,1}, [symbol] )) of OTAC radio processing modulation and coding scheme, and so on.

As described herein, the sensor nodes 204 can configure data with an OTAC configuration received from the aggregator node 202, configure a HE public configuration received from the aggregator node 202 for the configured data, pre-filter a data input using the OTAC configuration, encrypt the data input using the HE configuration, and/or apply the OTAC configuration to transmit the encrypted data to the OTAC aggregator node 202.

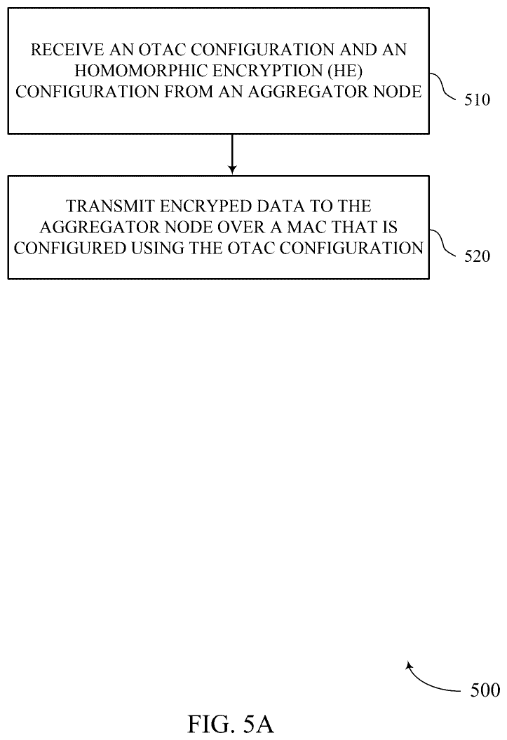

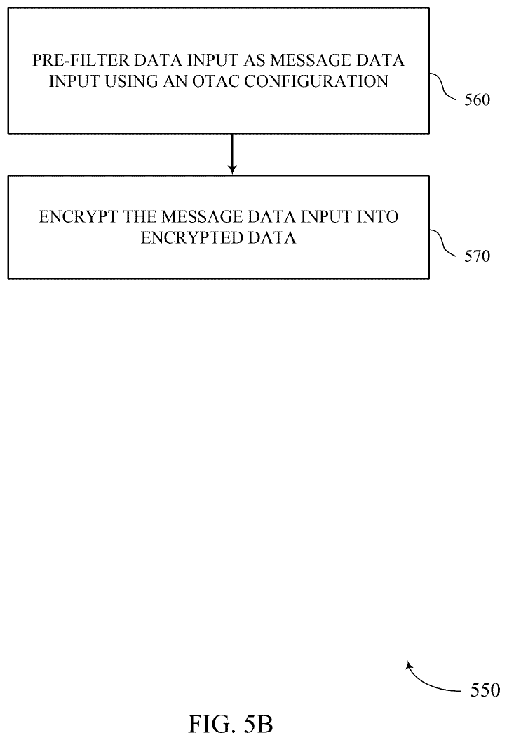

FIG. 5A illustrates a flowchart of a method 500 that supports a sensor node transmitting information over a MAC in accordance with aspects of the present disclosure. The operations of the method 500 may be implemented by a device or its components as described herein. For example, the operations of the method 500 may be performed by the UE 104 as described with reference to FIG. 8. In some implementations, the device may execute a set of instructions to control the function elements of the device to perform the described functions. Additionally, or alternatively, the device may perform aspects of the described functions using special-purpose hardware.

At 510, the method 500 may include receiving an OTAC configuration and a HE configuration from an aggregator node of a network. The operations of 510 may be performed in accordance with examples as described herein. In some implementations, aspects of the operations of 510 may be performed by a device as described with reference to FIG. 1.

At operation 520, the method 500 may include transmitting encrypted data to the aggregator node over a MAC, where the data is configured using the OTAC configuration and encrypted using the HE configuration. The operations of step 520 may be performed in accordance with examples as described herein. In some implementations, aspects of the operations of step 520 may be performed by a device as described with reference to FIG. 1.

FIG. 5B illustrates a flowchart of a method 550 that supports a sensor node encrypting data having an OTAC configuration in accordance with aspects of the present disclosure. The operations of the method 550 may be implemented by a device or its components as described herein. For example, the operations of the method 550 may be performed by the user equipment 104 as described with reference to FIG. 8. In some implementations, the device may execute a set of instructions to control the function elements of the device to perform the described functions. Additionally, or alternatively, the device may perform aspects of the described functions using special-purpose hardware.

At 560, the method 550 may include pre-filtering data input as message data input using an OTAC configuration. In some cases, the data input is pre-filtered using the OTAC configuration set or provided by the aggregator node 202. The operations of 560 may be performed in accordance with examples as described herein. In some implementations, aspects of the operations of 560 may be performed by a device as described with reference to FIG. 1.

At 570, the method 550 may include encrypting the message data input into encrypted data. In some cases, the message data input is encrypted using the HE configuration set provided by the aggregator node 202. The operations of 560 may be performed in accordance with examples as described herein. In some implementations, aspects of the operations of 560 may be performed by a device as described with reference to FIG. 1.

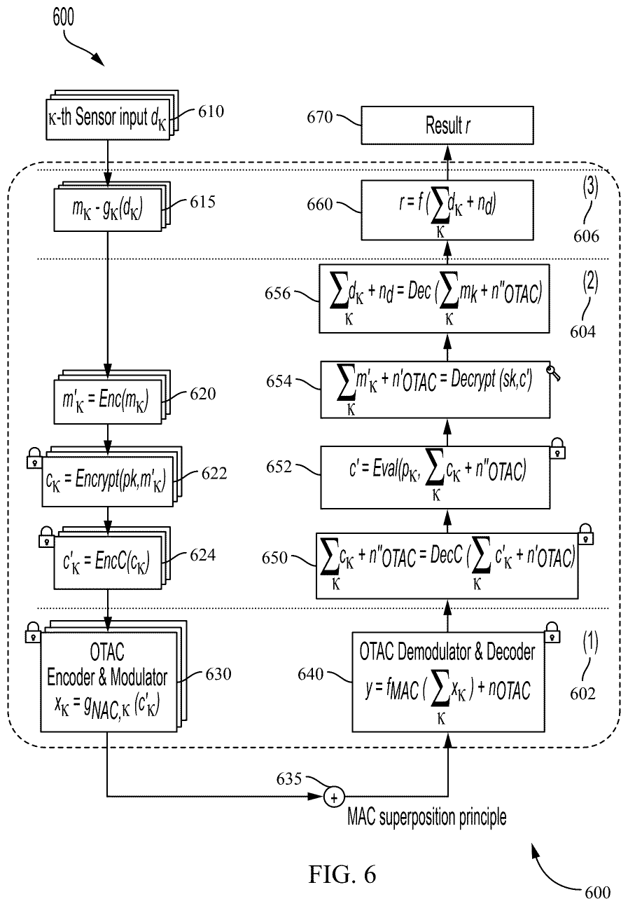

FIG. 6 illustrates an example of a diagram that supports an example OTAC scheme 600 that performs encrypted OTAC in accordance with aspects of the present disclosure. The diagram presents an example of processing data within the OTAC scheme 600, where the scheme includes an aggregator node (e.g., the aggregator node 202) and two or more sensor nodes (e.g., the K sensor nodes 204).

The OTAC scheme (with homomorphic encryption) has multiple processing domains (e.g., a layered processing), including an OTAC transceiver/radio domain 602, a HE security domain 604, and an OTAC analytics domain 606. The layered processing, in some cases, is stacked on top of the fundamental aggregation medium (e.g., the MAC), which provides the OTAC physical computation domain intrinsic to the OTAC scheme.

Following the OTAC scheme 600 (e.g., OTAC with HE having k-th sensor node processing) of FIG. 6, the sensor nodes 204 perform pre-filtering processing of input data dₖ 610 as OTAC pre-filtered input data, mₖ=gₖ(dₖ), 615 based on the OTAC analytics configuration of a processing pre-filter gₖ(•). The sensor nodes 204 perform HE security domain processing (e.g., in the HE security domain 604) to generate an encrypted version of the OTAC pre-filtered input data 615 as a ciphertext representation to be transmitted over the OTAC transceiver/radio domain 602. Further, the sensor nodes 204 perform OTAC radio processing and transmission 630 in UL over the MAC with superposition 635 whereby the generated waveform encodes, pre-filters for distributed MAC matching, and modulates the ciphertext representation.

The HE security domain 604 processing that generates the ciphertext representation of the OTAC data includes an encoding mₖ′=Enc(mₖ) 620 as an invertible embedding of the data input space D [symbol] mₖ to the plaintext space P (e.g., [symbol] _{q}[x]/(x^{N}+1) for CKKS, BFV schemes, [symbol] ₊ for Paillier scheme and so on) of the selected HE cryptographic scheme.

The HE security domain 604 also includes an encryption 622 to a ciphertext cₖ=Encrypt (pk, m′ₖ) of the encoded plaintext 620 of the OTAC pre-filtered input data 615 using the HE public configuration (e.g., the selected HE scheme and the pk), and an invertible encoding c′ₖ=EncC(cₖ) 624 of the ciphertext of the selected HE cryptographic scheme to the ciphertext representation corresponding to an intermediate space (e.g., ( [symbol] , {0,1}, [symbol] )) of the OTAC radio processing modulation and coding scheme.

In some cases, the encoding c′ₖ=EncC(cₖ) 624 of the ciphertext of the selected HE cryptographic scheme to the ciphertext representation corresponding to the intermediate space of the OTAC radio processing modulation and coding scheme may be a simple pass-through, a binary representation, a number theoretic mapping (e.g., Number Theoretic Transform), a harmonic representation (e.g., modified Fast Fourier Transform from polynomial rings to complex space), and so on.

The aggregator node 202 performs OTAC radio processing 640 of the reception over the MAC of the superimposed waveforms, whereby the processing of the superimposed waveform demodulates, filters by ƒ_{MAC} and matches the MAC channel given the CSI of each of the superimposed sensor nodes, and decodes the received information to a noisy ciphertext representation corresponding to an intermediate space e.g., ( [symbol] , {0,1}, [symbol] )) based on the configured OTAC radio processing modulation and coding scheme.

The HE security domain 604 generates a decrypted plaintext version of the OTAC received data whereby an additive homomorphism evaluation for the noisy ciphertext of the OTAC superimposed data is considered. Further, the node 202 performs filtering processing of the OTAC aggregated data Σₖ dₖ+n_{d} to yield the objective function result r=ƒ(Σₖ dₖ+n_{d}) 660, which is output as the result 670 in the aggregator node 202.

In some cases, the HE security domain 604 generates the plaintext representation of the OTAC aggregated data transmissions by decoding Σₖ cₖ+n″_{OTAC}=DecC(Σk c′ₖ+n′_{OTAC}) 650 to a ciphertext based on the HE selected scheme of the noisy ciphertext representation corresponding to the intermediate space of the configured OTAC radio processing modulation and coding scheme.

The HE security domain 604 can perform a homomorphic additive evaluation procedure c′=Eval(pk, Σₖ cₖ+n″_{OTAC}) 652 of the ciphertext given the HE selected scheme, a decryption to a plaintext result of the OTAC aggregated result and evaluated ciphertext as Σₖ m′ₖ+n′_{OTAC}=Decrypt(sk, c′) 654, and/or a decoding of the plaintext result as Σk dₖ+n_{d}=Dec(Σₖ mₖ+n″_{OTAC}) 656 by the inverse of the embedding used to encode the data input space given the selected HE cryptographic scheme.

In some cases, given the inherent noise of the receiver at the aggregator node 202, the non-ideal CSI estimates, the non-ideal time advance processing, and/or the non-ideal MAC matching to an equivalent normalized MAC channel, the result obtained by OTAC with HE is inherently a noisy computation of the desired function. However, the noisy computation is an inherent component of OTAC, and as such is based on established OTAC methods that the SNR of the result can be optimized and increased using various OTAC and HE configurations for the proposed schemes.

In some cases, the decoding DecC(Σₖ c′ₖ+n′_{OTAC}) 650 to the ciphertext space of the ciphertext representation corresponding to the intermediate space of the OTAC radio processing modulation and coding scheme given the selected HE cryptographic scheme may be a simple pass-through, a binary representation, an inverse number theoretic mapping (e.g., inverse of Number Theoretic Transform), an inverse harmonic representation (e.g., modified inverse of Fast Fourier Transform from polynomial rings to complex space), and so on. Further, the OTAC scheme 600 may determine a public-private key pair based on its selected HE scheme and determined HE configuration.

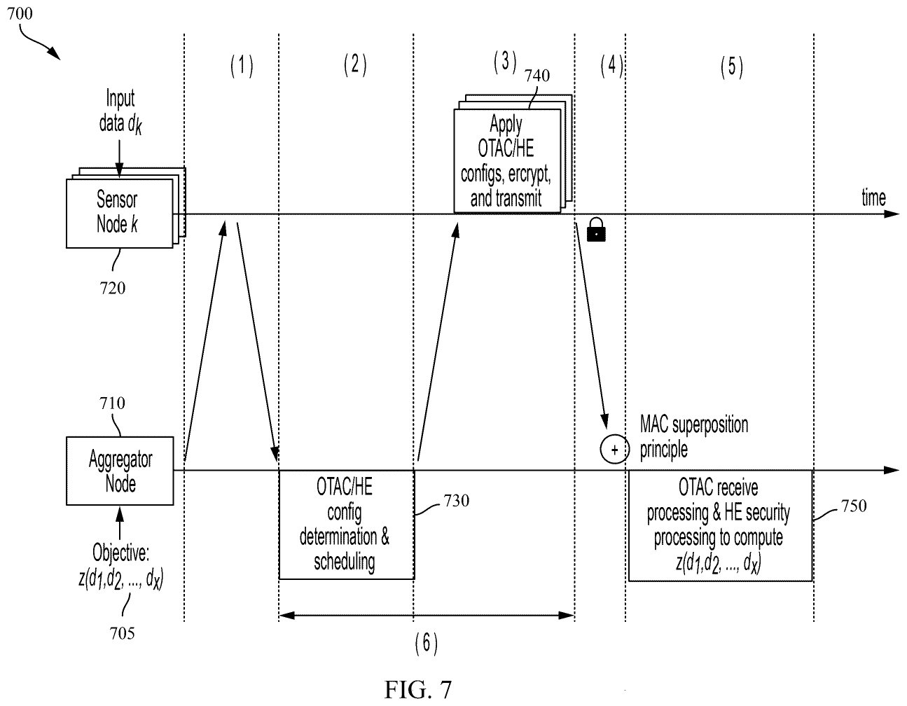

FIG. 7 illustrates an example of a diagram 700 that supports timing of information transmission in an OTAC system or OTAC scheme in accordance with aspects of the present disclosure. A generic multivariate function z(d₁, d₂, . . . , dₖ) 705 decomposable as ƒ(Σₖ dₖ) is to be computed as the OTAC objective function for K sensor nodes 204.

In a first time window (1), the aggregator node 710 performs knowledge acquisition. In some cases, the knowledge acquisition includes acquiring CSI information, determining timing advance configurations, and/or determining HE capabilities of K sensor nodes 720. The knowledge acquisition operation is performed by DL and UL communications with each of the K sensor nodes, whereby the DL communication may be of broadcast, multicast or unicast nature, and the UL assumes orthogonal multiple access schemes between the aggregator node 710 and the sensor nodes 720. For CSI and timing advance acquisition, reference signals are used between the aggregator node 720 and the sensor nodes 720 for increased reliability and accuracy over alternative blind detection and estimation methods.

In a second time window (2), the aggregator node 710 processes 730 the information acquired to determine the OTAC configuration, performs HE scheme selection, and subsequently determines a HE configuration and a HE public configuration thereof. In some examples, a CKKS cryptographic system on ring polynomials for complex numbers approximate computations as a SHE or FHE is selected by the aggregator node 710. In other examples, the aggregator node 710 selects a Paillier additive PHE cryptosystem for operation on integers with an associated ciphertext log-transform encoding onto OTAC waveforms for MAC superposition.

In a third time window (3), the aggregator node 710 schedules 740 the UL transmissions of the K sensor nodes 720 using the determined OTAC and public HE configurations.

In a fourth time window (4), the K sensor nodes 720 simultaneously transmit, using the same radio resources, their encrypted OTAC filtered waveforms (e.g., generated by the OTAC configuration and the HE configurations) which are inherently aggregated by MAC superposition principle.

In a fifth time window (5), the aggregator node 710 performs the techniques described herein to receive, decrypt and evaluate 750 the desired function z(d₁, d₂, . . . , dₖ) at the point of the OTAC aggregated data by the MAC superposition. In some cases, the time span between time window (1) and time window (4), denoted time window (6), is within a wireless channel coherence time for the end-to-end processing to yield satisfactory SNR of the objective function computation given the OTAC error propagation under erroneous or old CSI estimates.

Thus, as described herein, the technology, which combines OTAC and HE to transmit and compute data over a MAC, creates, generates, or enables cryptographically secured/encrypted OTAC for network resources. Further, the OTAC schemes described herein provides a computationally meaningful and scalable integration of the OTAC and HE processing over additive homomorphisms to yield approximate evaluations of any multivariate continuous functions, while preserving the strong security guarantees (potentially post-quantum) of a HE scheme, among other benefits.

FIG. 8 illustrates an example of a block diagram 800 of a device 802, which supports encrypted OTAC in accordance with aspects of the present disclosure. The device 802 may be an example of the base station 102 or aggregator node 202, as described herein. The device 802 may support wireless communication with one or more base stations 102, UEs 104, or any combination thereof. The device 802 may include components for bi-directional communications including components for transmitting and receiving communications, such as a communications manager 804, a processor 806, a memory 808, a receiver 810, transmitter 812, and an I/O controller 814. These components may be in electronic communication or otherwise coupled (e.g., operatively, communicatively, functionally, electronically, electrically) via one or more interfaces (e.g., buses).

The communications manager 804, the receiver 810, the transmitter 812, or various combinations thereof or various components thereof may be examples of means for performing various aspects of the present disclosure as described herein. For example, the communications manager 804, the receiver 810, the transmitter 812, or various combinations or components thereof may support a method for performing one or more of the functions described herein.

In some implementations, the communications manager 804, the receiver 810, the transmitter 812, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 806 and the memory 808 coupled with the processor 806 may be configured to perform one or more of the functions described herein (e.g., by executing, by the processor 806, instructions stored in the memory 808).

Additionally or alternatively, in some implementations, the communications manager 804, the receiver 810, the transmitter 812, or various combinations or components thereof may be implemented in code (e.g., as communications management software or firmware) executed by the processor 806. If implemented in code executed by the processor 806, the functions of the communications manager 804, the receiver 810, the transmitter 812, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 804 may be configured to perform various operations (e.g., receiving, monitoring, transmitting) using or otherwise in cooperation with the receiver 810, the transmitter 812, or both. For example, the communications manager 804 may receive information from the receiver 810, send information to the transmitter 812, or be integrated in combination with the receiver 810, the transmitter 812, or both to receive information, transmit information, or perform various other operations as described herein. Although the communications manager 804 is illustrated as a separate component, in some implementations, one or more functions described with reference to the communications manager 804 may be supported by or performed by the processor 806, the memory 808, or any combination thereof. For example, the memory 808 may store code, which may include instructions executable by the processor 806 to cause the device 802 to perform various aspects of the present disclosure as described herein, or the processor 806 and the memory 808 may be otherwise configured to perform or support such operations.

For example, the communications manager 804 may support wireless communication at a first device (e.g., the device 802) in accordance with examples as disclosed herein. The communications manager 804 may be configured as or otherwise support a means for securing OTAC over a MAC. For example, the communications manager can: transmit to multiple sensor nodes an over-the-air computing (OTAC) configuration and a Homomorphic Encryption (HE) configuration, receive encrypted data over a MAC based on the OTAC configuration from the multiple sensor nodes, and decrypt the received encrypted data using the HE configuration.

The processor 806 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 806 may be configured to operate a memory array using a memory controller. In some other implementations, a memory controller may be integrated into the processor 806. The processor 806 may be configured to execute computer-readable instructions stored in a memory (e.g., the memory 808) to cause the device 802 to perform various functions of the present disclosure.

The memory 808 may include random access memory (RAM) and read-only memory (ROM). The memory 808 may store computer-readable, computer-executable code including instructions that, when executed by the processor 806 cause the device 802 to perform various functions described herein. The code may be stored in a non-transitory computer-readable medium such as system memory or another type of memory. In some implementations, the code may not be directly executable by the processor 806 but may cause a computer (e.g., when compiled and executed) to perform functions described herein. In some implementations, the memory 808 may include, among other things, a basic I/O system (BIOS) which may control basic hardware or software operation such as the interaction with peripheral components or devices.

The I/O controller 814 may manage input and output signals for the device 802. The I/O controller 814 may also manage peripherals not integrated into the device 802. In some implementations, the I/O controller 814 may represent a physical connection or port to an external peripheral. In some implementations, the I/O controller 814 may utilize an operating system such as iOS®, ANDROID®, MS-DOS®, MS-WINDOWS®, OS/2®, UNIX®, LINUX®, or another known operating system. In some implementations, the I/O controller 814 may be implemented as part of a processor, such as the processor 806. In some implementations, a user may interact with the device 802 via the I/O controller 814 or via hardware components controlled by the I/O controller 814.

In some implementations, the device 802 may include a single antenna 816. However, in some other implementations, the device 802 may have more than one antenna 816, which may be capable of concurrently transmitting or receiving multiple wireless transmissions. The receiver 810 and the transmitter 812 may communicate bi-directionally, via the one or more antennas 816, wired, or wireless links as described herein. For example, the receiver 810 and the transmitter 812 may represent a wireless transceiver and may communicate bi-directionally with another wireless transceiver. The transceiver may also include a modem to modulate the packets, to provide the modulated packets to one or more antennas 816 for transmission, and to demodulate packets received from the one or more antennas 816.

In addition to supporting wireless communication at a first device, such as the base station 102, the communications manager 804, when implemented as part of the UE 104 (or sensor node 204), can support wireless communication at a second device (e.g., the sensor node 204) in accordance with examples as disclosed herein. The communications manager 804 may be configured as or otherwise support a means for encrypting and transmitting data from the sensor node 204. For example, the communications manager 804 can: receive an OTAC configuration and a HE configuration from an aggregator node of a network and transmits encrypted data to the aggregator node over a MAC, where the encrypted data is configured using the OTAC configuration and encrypted using the HE configuration.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A network entity for wireless communication, comprising:
at least one memory; and
at least one processor coupled with the at least one memory and configured to cause the network entity to:
transmit to multiple sensor nodes an over-the-air computing (OTAC) configuration and a Homomorphic Encryption (HE) configuration;
receive encrypted data over a multiple access channel (MAC) based on the OTAC configuration from the multiple sensor nodes; and
decrypt the received encrypted data using the HE configuration.

2. The network entity of claim 1, wherein, to decrypt the received encrypted data using the HE configuration, the at least one processor is configured to cause the network entity to:
decrypt the received encrypted data as an OTAC aggregated result; and
compute an objective function for the data that is based on the OTAC aggregated result and the OTAC configuration.

3. The network entity of claim 1, wherein the HE configuration includes a public HE configuration and a private HE configuration.

4. The network entity of claim 3, wherein the at least one processor is further configured to cause the network entity to configure the multiple sensor nodes to encrypt data using the public HE configuration.

5. The network entity of claim 1, wherein the HE configuration comprises a Partial Homomorphic Encryption (PHE) encryption scheme, a Somewhat Homomorphic Encryption (SWE) encryption scheme, or a Full Homomorphic Encryption (FHE) encryption scheme, or a combination thereof.

6. The network entity of claim 1, wherein the at least one processor is further configured to cause the network entity to determine the HE configuration based on one or more factors, including:
a desired bit security guarantee;
a data input space;
a desired threshold of sensor nodes superposed by a MAC superposition of the MAC;
a desired threshold of residual noise during the decryption of the received encrypted data without a decryption processing failure;
a function objective calculated during the decryption of the received encrypted data;
a table description of supported HE cryptographic schemes; or
a modulation and coding scheme of the OTAC configuration; or a combination thereof.

7. The network entity of claim 1, wherein the HE configuration is based on:
a selected HE cryptographic scheme;
a public-private key pair;
a relinearization key;
a secret key;
an invertible encoding of data input space to plaintext space of a selected HE scheme; or
an invertible encoding of ciphertext space of a selected HE scheme to an intermediate space of an OTAC transceiver processing modulation and coding scheme for the OTAC configuration.

8. The network entity of claim 1, wherein, to decrypt the received encrypted data using the HE configuration, the at least one processor is configured to cause the network entity to embed an asymmetric cryptographic primitive.

9. The network entity of claim 1, wherein the HE configuration is homomorphic with respect to addition operation.

10. The network entity of claim 1, wherein the at least one processor is further configured to cause the network entity to determine the OTAC configuration based on one or more factors, including:
a function objective to be calculated;
channel state information (CSI) for the multiple sensor nodes;
multiple reference signals (RS) reports for timing advance determination for the multiple sensor nodes;
one or more precoders and combiners for spatial beamforming available to the multiple sensor nodes;
radio transceiver capabilities of the multiple sensor nodes; or
a set of available time and frequency communication resources, or a combination thereof.

11. The network entity of claim 1, wherein the OTAC configuration is based on:
an OTAC radio processing configuration of an OTAC transmission filter; or
an OTAC analytics processing configuration of a pre-filter, or both.

12. The network entity of claim 11, wherein the OTAC radio processing configuration of the OTAC transmission filter, for each of the multiple sensor nodes, includes an indication signaling one or more of:
a receiver spatial filter of the network entity;
a transmitter spatial filter at the sensor node;
a transmission pattern for time multiplexing;
a transmission pattern for frequency multiplexing; or
a timing advance configuration.

13. A sensor node for wireless communication, comprising:
at least one memory; and
at least one processor coupled with the at least one memory and configured to cause the sensor node to:
receive an over-the-air computing (OTAC) configuration and a Homomorphic Encryption (HE) configuration from an aggregator node of a network; and
transmit encrypted data to the aggregator node over a multiple access channel (MAC),
wherein the encrypted data is configured using the OTAC configuration and encrypted using the HE configuration.

14. The sensor node of claim 13, wherein the at least one processor is further configured to cause the sensor node to:
pre-filter data input as message data input using the OTAC configuration; and
encrypt the message data input as the encrypted data using the HE configuration.

15. The sensor node of claim 13, wherein the HE configuration is a public HE configuration that includes:
a selected HE cryptographic scheme;
a public encryption key;
an invertible encoding of data input space to plaintext space of a selected HE scheme;
an invertible encoding of ciphertext space of a selected HE scheme to an intermediate space of an OTAC transceiver processing modulation and coding scheme;
or combinations thereof.

16. The sensor node of claim 13, wherein the at least one processor is further configured to cause the sensor node to:
encode a data input from a data space to a plaintext space;
encrypt a plaintext representation to a ciphertext representation via cryptographic additive homomorphic encryption; or
encode a ciphertext representation to an input space of the OTAC configuration.

17. The sensor node of claim 13, wherein the OTAC configuration is based on:
an OTAC radio processing configuration of an OTAC transmission filter; or
an OTAC analytics processing configuration of a pre-filter.

18. The sensor node of claim 17, wherein the OTAC radio processing configuration of the OTAC transmission includes one or more of:
a receiver spatial filter of the aggregator node;
a transmitter spatial filter at the sensor node;
a transmission pattern for time multiplexing;
a transmission pattern for frequency multiplexing; and
a timing advance configuration.

19. A system for wireless communication, comprising:
an aggregator node that determines an objective function for encrypted data aggregated over a multiple access channel (MAC) accessed by multiple sensor nodes; and
multiple sensor nodes that simultaneously transmit encrypted data over the MAC to the aggregator node.

20. The system of claim 19, wherein the aggregator node applies an over-the-air computing (OTAC) configuration and a homomorphic encryption (HE) configuration to data transmitted over the MAC from the multiple sensor nodes to the aggregator node.
